(19) United States
(12) Patent Application Publication
(10) Pub. No.: US 2015/0058049 A1
(43) Pub. Date: Feb. 26, 2015

(54) SYSTEMS AND METHODS FOR IDENTIFYING AND ANALYZING A CUSTOMER QUEUE

(71) Applicant: RetailNext, Inc., San Jose, CA (US)

(72) Inventor: George SHAW, Palo Alto, CA (US)

(73) Assignee: RetailNext, Inc., San Jose, CA (US)

(21) Appl. No.: 13/970,866

(22) Filed: Aug. 20, 2013

(51) Int. Cl. G06Q 10/02

(52) U.S. Cl. CPC G06Q 10/02
USPC 705/5

(57) ABSTRACT

An image from a camera may be received and location coordinates of customers in the image may be identified. A line may be calculated based on the location coordinates and a join zone may be defined on the line. A location on the image corresponding to the join zone may be monitored. If a customer stands in the join zone for an amount of time, then the customer may be determined to have joined the customer queue. In response to the customer joining the customer queue, a new line may be calculated based on location coordinates of the first, second, and third customers in the image. Furthermore, a new join zone may be defined on the new line and a location on the image or video corresponding to the new join zone may be monitored for a subsequent customer joining the customer queue.

### FIELD OF THE DISCLOSURE

The present disclosure generally relates to the field of information technology. In some embodiments, the disclosure relates to identifying and analyzing a customer queue.

### BACKGROUND

Tracking subjects through a real world space offers benefits in a variety of areas and applications, including commercial, business, corporate, security, government, science, and other environments. For example, brick and mortar businesses have long desired to gather data that would allow the businesses to better understand customer behavior. Such data may be used to make decisions with regard to merchandising, advertising, pricing, staffing, designing of new in-store concepts, and understanding how customers interact within a store. For example, the data may be used to understand how customers stand in a queue, interact with store displays, make correlations with sales data, calculate conversion rates, identify good locations for merchandise, identify poor performing products and locations, improve store layout, provide targeted promotions, and much more.

Providing traditional brick and mortar business retailers with a data-driven approach can help the businesses provide the best possible shopping experience, stay ahead of constantly evolving customer needs, reduce cost, and significantly increase revenue per square foot. For example, businesses may seek to improve their customers' shopping experience by optimizing an amount of time a customer waits in a customer queue to make a purchase at a point of sale location (e.g., a cash register, store employee, self checkout kiosk, etc.). As such, a system and method to identify a customer queue and then analyze data associated with the identified customer queue would facilitate businesses seeking to improve the shopping experience for their customers.

### BRIEF SUMMARY OF THE DISCLOSURE

In some embodiments, customers in a queue may be identified. For example, a first customer and a second customer may be identified in the queue in at least one image. Location coordinates corresponding to locations of the first customer and the second customer in the at least one image may be determined. A line based on the location coordinates of the first customer and the second customer may be calculated. Furthermore, a join zone may be defined at a location coordinate that is on the calculated line. In some embodiments, a third customer may be detected to have entered a location of at least one additional image corresponding to the location coordinate of the join zone and a determination may be made that the third customer has joined the queue in response to the third customer entering into the location corresponding to the join zone.

In some embodiments, a second line is calculated in response to the determination that the third customer has joined the queue, the second line is based on location coordinates of the first customer, second customer, and third customer. The line may be calculated based on a first equation while the second line is calculated based on a second equation. As such, the first equation may be different than the second equation. Furthermore, the second equation may be based on an ordinary least squares linear regression.

In some embodiments, a second join zone may be defined at location coordinates that are on the calculated second line. For example, the location coordinates for the second join zone may be placed beyond the location coordinates of the third customer. Additionally, an amount of space between the location coordinates for the second join zone and the third customer may be based on an amount of space between location coordinates of the first, second, and third customers. The boundaries of the second join zone may be based on an amount of distance the location coordinates of the first, second, and third customers are from the second line.

In some embodiments, the determination of the third customer joining the queue may further be in response to the third customer being in the location corresponding to the join zone for at least a threshold amount of time.

### BRIEF DESCRIPTION OF THE FIGURES

FIG. 1 shows a block diagram of a client-server system and network in accordance with some embodiments of the disclosure.

FIG. 2 illustrates a detailed block diagram of an example client or computer in which some embodiments of the disclosure may operate.

FIG. 3 shows a block diagram of a client computer system in accordance with some embodiments.

FIG. 4 shows a block diagram of an example environment including one or more cameras and a system for identifying and analyzing customer queues.

FIG. 5 illustrates an example environment using an approach to identify a customer queue based on a queue zone in accordance with some embodiments of the disclosure.

FIG. 6 illustrates an example environment when using an approach to identify a customer queue and a customer passing through the customer queue.

FIG. 7 illustrates an example environment when using an approach to identify a customer queue when a customer is beyond the boundaries of the queue zone.

FIG. 8 shows an example environment using an approach to determine a line based on customers in a customer queue in accordance with some embodiments.

FIG. 9 illustrates an example environment using an approach based on a join zone to determine whether an additional customer has joined a customer queue in accordance with some embodiments of the disclosure.

FIG. 10 illustrates an example environment showing a customer being identified as joining the customer queue based on the customer standing in a join zone.

FIG. 11 illustrates an example environment showing the creation of a new join zone in accordance with some embodiments of the disclosure.

FIG. 12 is a flow diagram illustrating a method to calculate or generate a line associated with a customer queue in accordance with some embodiments.

FIG. 13 is a flow diagram illustrating a method to detect a new customer joining a customer queue and generating a new join zone in response to the new customer joining the customer queue.

### DETAILED DESCRIPTION

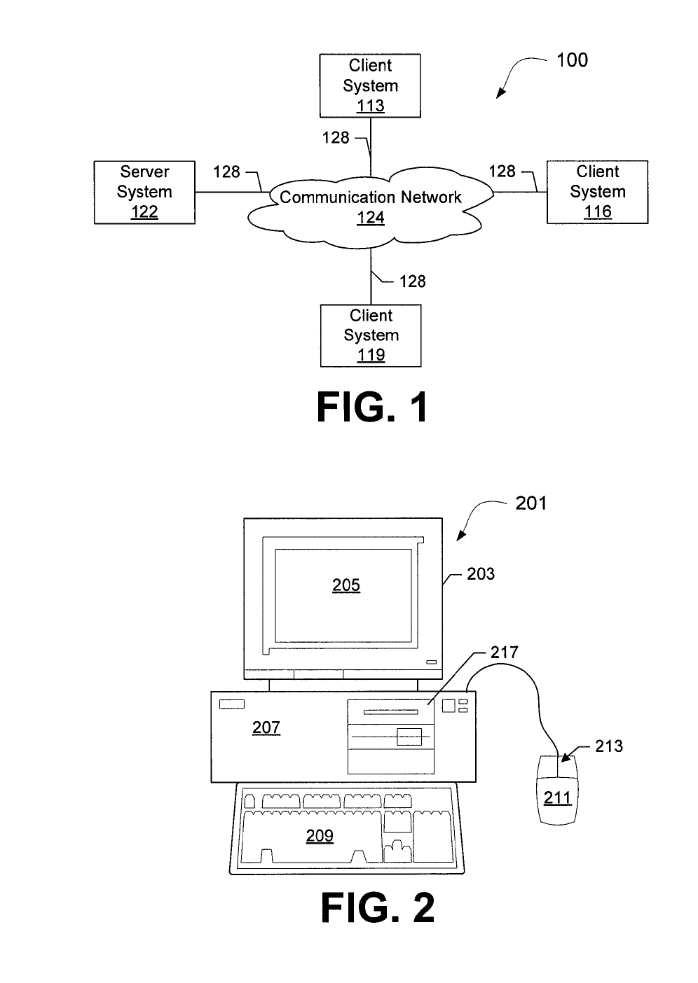

FIG. 1 is a simplified block diagram of a distributed computer network 100. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment and is not intended to limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 enable users to access and query information stored by server system 122. In a specific embodiment, a “Web browser” application executing on a client system enables users to select, access, retrieve, or query information stored by server system 122. Examples of web browsers include the Internet Explorer® browser program provided by Microsoft® Corporation, and the Firefox® browser provided by Mozilla® Foundation, and others.

FIG. 2 shows an example client or server system. In an embodiment, a user interfaces with the system through a computer workstation system, such as shown in FIG. 2, which shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc®), flash and other nonvolatile solid-state storage (e.g., USB flash drive), battery-backed-up volatile memory, tape storage, reader, and other similar media, and combinations of these.

A computer-implemented or computer-executable version of the disclosure may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software may also be stored or reside on mass storage device 217 (e.g., hard disk, magnetic disk, tape, or CD-ROM). As a further example, code may be transmitted via wires, radio waves, or through a network such as the Internet.

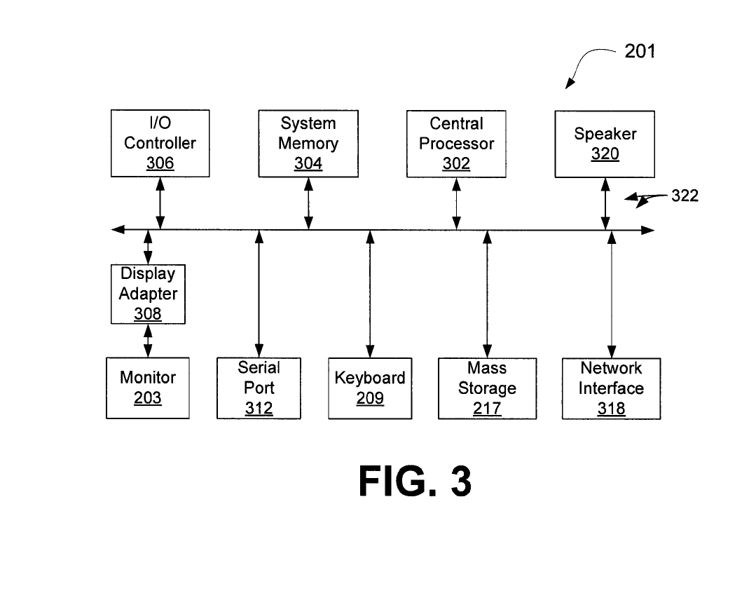

FIG. 3 shows a system block diagram of computer system 201. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. In an embodiment, a computer system includes additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a suitable computer system. Other configurations of subsystems suitable for use will be readily apparent to one of ordinary skill in the art.

Computer software products may be written in any of various suitable programming languages, such as C, C++, C#, Pascal, Fortran, Peri, Matlab®, SAS, SPSS, JavaScript®, AJAX, Java®, SQL, and XQuery (a query language that is designed to process data from XML files or any data source that can be viewed as XML, HTML, or both). The computer software product may be an independent application with data input and data display modules. Alternatively, the computer software products may be classes that may be instantiated as distributed objects. The computer software products may also be component software such as Java Beans® (from Oracle Corporation) or Enterprise Java Beans® (EJB from Oracle Corporation). In a specific embodiment, the present disclosure provides a computer program product which stores instructions such as computer code to program a computer to perform any of the processes or techniques described.

An operating system for the system may be one of the Microsoft Windows® family of operating systems (e.g., Windows 95®, 98, Me, Windows NT®, Windows 2000®, Windows XP®, Windows XP® x64 Edition, Windows Vista®, Windows 7®, Windows CEO, Windows Mobile®), Linux, HP-UX, UNIX, Sun OS®, Solaris®, Mac OS X®, Alpha OS®, AIX, IRIX32, or IRIX64. Other operating systems may be used. Microsoft Windows® is a trademark of Microsoft® Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

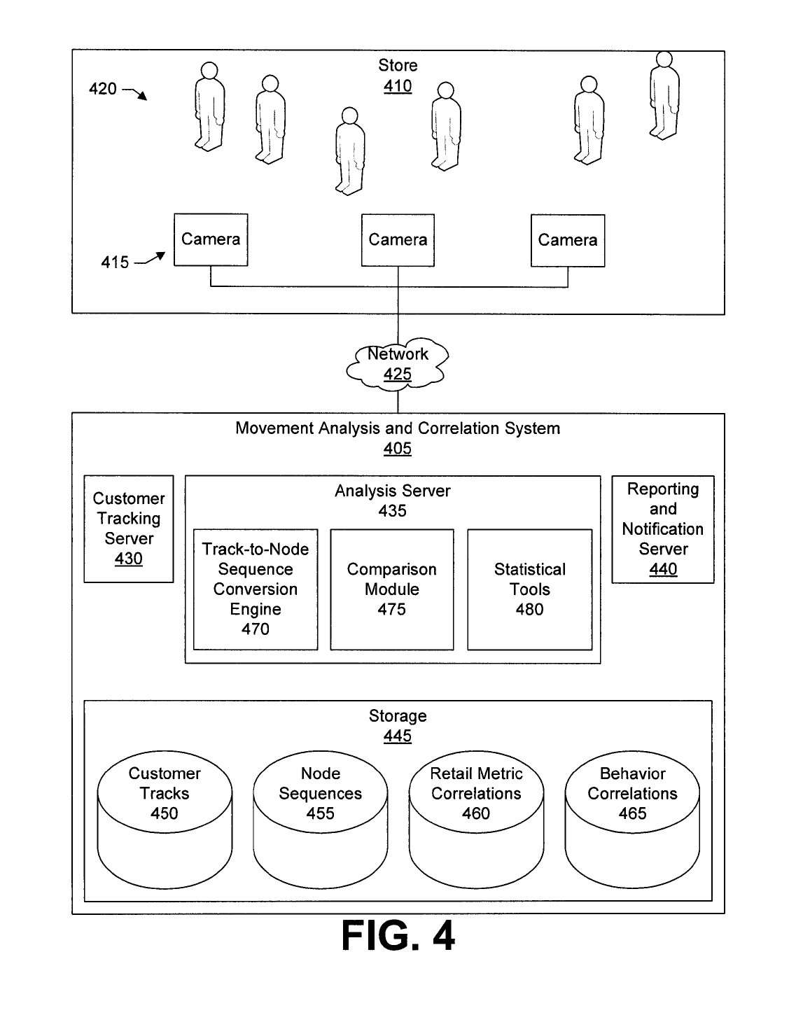

FIG. 4 shows a block diagram of an environment in which a system 405 for analyzing customer movement for identifying a customer queue may be used. A store 410 includes a set of cameras 415 and subjects 420 (e.g., customers). The subjects' movements may be captured and tracked by at least one camera. The cameras may be connected via a network 425 to system 405. The system includes a subject or customer tracking server 430, an analysis server 435, a reporting and notification server 440, and storage 445. The storage includes a database 450 to store customer tracking data and a database 465 to store customer queue data.

The network is as shown in FIG. 1 and described above. The servers include components similar to the components shown in FIG. 3 and described above. For example, a server may include a processor, memory, applications, and storage.

In some embodiments, the store may be a retail space (e.g., “brick and mortar” store) and the subjects are people or human beings. For example, the subjects can include, but are not limited to, customers, consumers, or shoppers, salespersons, adults, children, toddlers, teenagers, females, males, etc. The retail space may be, but is not limited to, a grocery store, supermarket, clothing store, jewelry store, department store, discount store, warehouse store, variety store, mom-and-pop, specialty store, general store, convenience store, hardware store, pet store, toy store, mall, etc.

A feature of the system provides, given a set of movement traces (i.e., locations over time) for customers in a retail environment, analyzing movement patterns in several ways. The system can use the analysis to identify customer queues and to perform statistical analysis on the customers and/or customer queues. In some embodiments, the movement or tracking data is placed into various data structures (e.g., a spatial histogram or star graph). The system derives a set of metrics related to the data structures. Each metric can be a single numerical result that quantifies movement patterns in some unique way. Taken together, these metrics help to describe the movement pattern under examination and to identify a customer queue.

A specific implementation of the system is referred to as RetailNext from RetailNext, Inc. of San Jose, Calif. This system provides a comprehensive in-store analytics platform that pulls together a comprehensive set of information for retailers to make intelligent business decisions about their retail locations and visualizes it in a variety of automatic, intuitive views to help retailers find those key lessons to improve the stores. The system provides the ability to connect traffic, dwell times, and other shopper behaviors to actual sales at the register. Users can view heat maps of visitor traffic, measure traffic over time in the stores or areas of the stores, and connect visitors and sales to specific outside events. The system can provide micro-level conversion information for areas like departments, aisles, and specific displays, to make directly actionable in-store measurement and analysis.

The tracking server may be responsible for tracking customers as they move throughout the store. The tracking server can track a particular customer as the customer moves across the different camera views of each camera. A track is a path that a customer followed during the customer's visit to the store. Tracking data is collected and stored in tracking database 450.

The analysis server includes a conversion engine 470, a comparison module 475, and statistical tools 480. The conversion engine is responsible for converting a track stored database 450 into a node sequence for storage in database 455. A node sequence represents an abstraction of the path that the customer followed while in the store. The node sequence includes an ordered set of node indices. Each node index corresponds to a node that is placed at a location on a floor plan of the space.

The comparison module can compare one node sequence to another node sequence. The comparison can be used to identify common movement patterns, different movement patterns, frequent movement patterns, outlier movement patterns, facilitate machine learning, or combinations of these. The statistical tools include a package of statistical tools to help quantify and analyze movement patterns. In a specific implementation, a statistical analysis performed by the system includes calculating a Kullback-Leibler (KL) divergence, entropy, Ripely's K, a string edit or Levenshtein distance, or combinations of these.

Database 460 stores correlations between sales data, key performance indicators (KPI)s, and other retail metrics to customer movement patterns. Retail metrics or sales data may be imported from an external system such as point of sales (POS) device, an inventory management system, customer relationship management (CRM) system, financials system, warehousing system, or combinations of these. In some embodiments, a retail metric includes conversion data or a conversion rate. A conversion can be expressed as a percentage of customers that enter the store and purchase a good, service, or both. The conversion can be calculated by dividing a number of sales transactions by a number of customers who enter the store. Conversion measures the amount of people who enter store versus the number of customers who make a purchase. Conversion helps to provide an indication of how effective the sales staff is at selling products and the number of customers visiting the store.

Conversions can be for any time period such as an hour, day, week, month, quarter (e.g., fall, winter, spring, or summer), year, and so forth. A conversion may be calculated for a particular day such as a weekday (e.g., Monday, Tuesday, Wednesday, Thursday, Friday, Saturday, or Sunday), a weekend (e.g., Friday, Saturday, or Sunday), a holiday (e.g., Columbus Day, Veterans Day, or Labor Day), the day following Thanksgiving (e.g., Black Friday), and so forth.

Some other examples of metrics include, but is not limited to, traffic to a particular location in the store (e.g., traffic past a particular display), engagement (e.g., measurement of how well sales staff is engaging customers), sales per square foot, comparable-store sales (e.g., year-over-year sales performance), average sale per customer or transaction, cost of goods sold, markup percentage, inventory to sales ratio, average age of inventory, wages paid to actual sales, customer retention (e.g., number of repeat purchases divided by number of first time purchases), product performance (e.g., ranked listing of products by sales revenue), sales growth (e.g., previous period sales revenue divided by current period sales revenue), demographic metrics (e.g., total revenue per age, sex, or location), sales per sales associate (e.g., actual sales per associate per time period), average purchase value (e.g., total sales divided by number of sales), or customer queue analysis statistics as further discussed below.

The reporting and notification server is responsible for displaying reports and results from the data analysis, and generating and sending notifications and alerts. Results from the analysis may be displayed on graphical user interface (GUI), printed on paper, or both. The displayed results may include graphs (e.g., line graphs), charts (e.g., pie chart, bar chart, or area graphs), tables, text, or combinations of these. A notification or alert may include a text message (e.g., simple message service (SMS) message, or multimedia message service (MMS) message), email, phone call (e.g., recorded voice call), instant message (IM), or combinations of these.

Database 465 stores correlations between customer movement patterns and consumer behavior or actions. Actions that a customer may take inside the store include making a purchase, not making a purchase, shoplifting, talking to a salesperson, not talking to a salesperson, using a fitting room, not using a fitting room, pausing in front of display, walking past a display, and the like.

Further details with regard to a system utilizing cameras to generate customer tracks are discussed in U.S. patent application Ser. No. 13/603,832 (the '832 application), filed Sep. 5, 2012, which is herein incorporated by reference in its entirety. As discussed in the '832 application, a method to obtain the track includes projecting track data from each camera into a single unified coordinate space (e.g., “real space”), and matching and joining tracks belonging to a single tracked customer. In an implementation, tracking data includes a set of time-stamped points, each point being mapped to a position or location on a floor of the store. A point may be specified in a Cartesian coordinate system. For example, a point can include a pair of coordinates (e.g., an X-coordinate and a Y-coordinate). In an implementation, a track is defined by a set of points. Each point includes an X-coordinate value and a Y-coordinate value. The X-coordinate value represents a customer's position with respect to an X-axis. The Y-coordinate value represents the customer's position with respect to a Y-axis. Further discussion is provided in the '832 application. In some embodiments, the customer tracks may be used to identify customer locations and if a customer is standing in a join zone as discussed in further detail below.

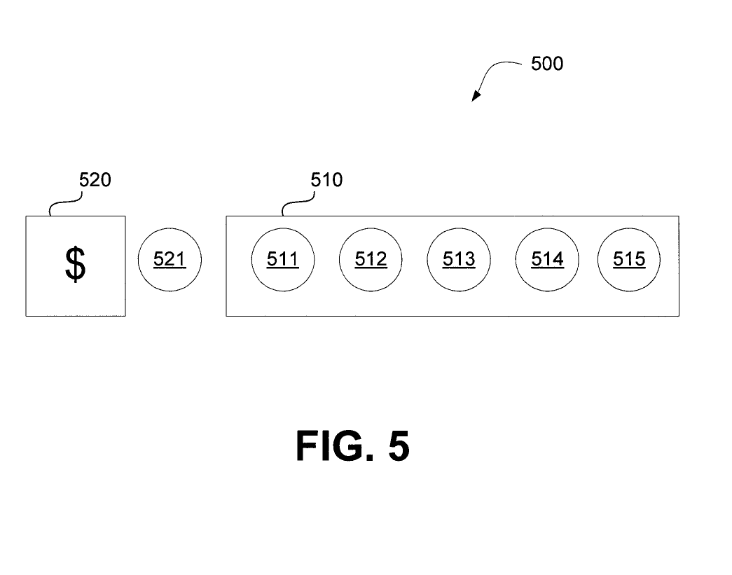

FIG. 5 illustrates an example environment 500 using an approach to identify a customer queue based on a queue zone. In general, the environment 500 may use one or more cameras (e.g., from the set of cameras 415) to track and identify customers within a queue zone. In some embodiments, the environment 500 may be a retail store and the tracked and identified subjects may be customers in the retail store. Furthermore, the queue zone 510 may be a zone or area associated with a point of sale location.

As shown in FIG. 5, the environment 500 may include a point of sale location 520 and a queue zone 510. In some embodiments, the point of sale location 520 may be associated with a customer 521. For example, the customer 521 may be placing a purchase of an item or service at the point of sale location 520. One or more cameras may be configured to track and identify additional customers who have entered the queue zone 510. In some embodiments, the queue zone 510 may be a predefined location on a store floor that one or more cameras may be monitoring. The customer 511 may also seek to place a purchase of an item or service at the point of sale location 520. However, since the customer 521 is currently being served at the point of sale location 520, the customer 511 may stand in line in the queue zone 510 until the customer 521 has left the point of sale location 520. Furthermore, additional customers may stand in line behind the customer 511. For example, customers 512, 513, 514, and 515 may stand in line behind the customer 511 in the queue zone 510. In some embodiments, a one or more cameras may track and identify customers who have entered the queue zone 510. For example, as shown in FIG. 5, a camera may identify that customers 511, 512, 513, 514, and 515 are currently in the queue zone 510. As such, the camera or system may determine that there are currently five customers in the queue zone 510.

As such, one or more cameras in a retail location may monitor a particular portion of the retail location. For example, at least one camera may monitor a queue zone and identify any customers who have entered the queue zone. The camera image or video may be used to determine the number of customers who are currently in the queue zone.

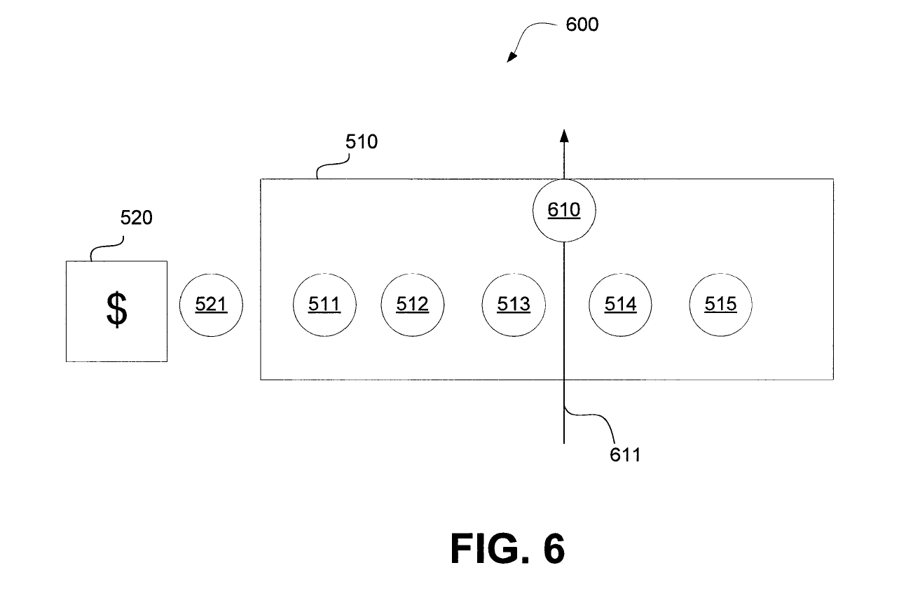

FIG. 6 illustrates an example environment 600 when using an approach to identify a customer queue and a customer passing through the customer queue. Similar to the example environment 500 of FIG. 5, the environment 600 may use one or more cameras (e.g., from the set of cameras 415) to track and identify customers within a queue zone 510 in front of a point of sale location 520 associated with a customer 521 currently being served.

As previously discussed, images or videos from the one or more cameras may be used to determine a number of customers in the queue zone 510. For example, customers 511, 512, 513, 514, and 515 may be identified as being in the queue zone 510. However, a customer 610 may pass through the queue zone 510 in a path 611. For example, the customer 610 may not intend to stand in the queue zone 510 and instead may cut through the queue zone 510 to reach another part of the retail location associated with the environment 600. As such, the customer 610 may follow the path 611, involving the customer 610 entering the queue zone 510 at a first location and exiting the queue zone 510 at a second location. However, in the approach using cameras to monitor the queue zone 510, the cameras or system may identify the customer 610 as being in the queue zone 510 and may thus incorrectly identify that the customer 610 is also standing in line in the queue zone 510 along with the customers 511, 512, 513, 514, and 515. As such, in such an environment and approach, the images for the one or more cameras monitoring the queue zone 510 may be used to incorrectly determine that there are currently six customers standing in line in the queue zone 510 as opposed to five customers standing in line in the queue zone 510.

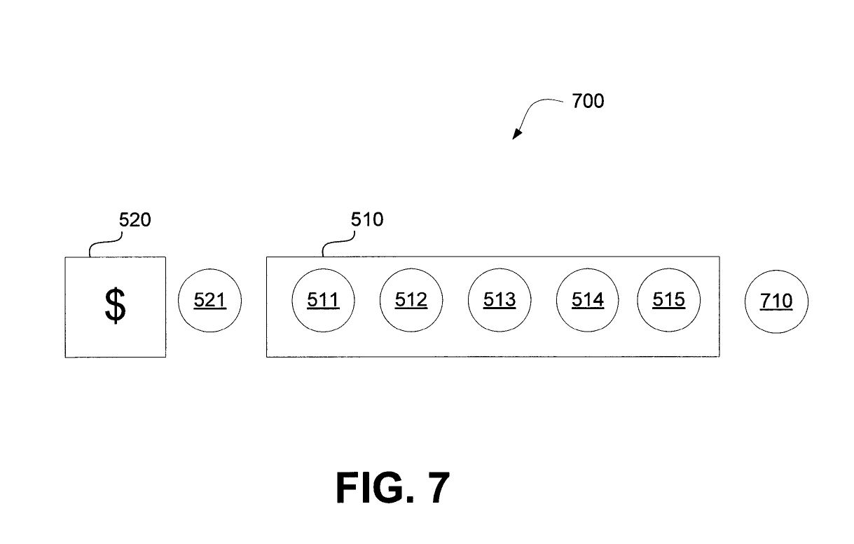

FIG. 7 illustrates an example environment 700 when using an approach to identify a customer queue when a customer is beyond the boundaries of the queue zone. Similar to the example environments 500 of FIGS. 5 and 600 of FIG. 6, the environment 700 may use one or more cameras (e.g., from the set of cameras 415) to track and identify customers within a queue zone 510 in front of a point of sale location 520 associated with a customer 521 currently being served.

As previously discussed, images or video from the one or more cameras may be used to determine a number of customers in the queue zone 510 (e.g., by identifying customer tracks). For example, as shown, the images may be used to identify customers that are currently in the queue zone 510 (e.g., customers 511, 512, 513, 514, and 515). However, in certain cases, the number of customers in a customer queue for a point of sale location at a retail store may exceed the capacity or boundaries of the queue zone 510. For example, as shown, the customer 710 may be in the customer queue along with customers 511, 512, 513, 514, and 515 for the point of sale location 520. However, the customer 710 may be standing outside of the queue zone 510. As such, images from cameras monitoring the queue zone 510 may not identify the customer 710 as standing in the customer queue along with the other customers in the queue zone 510.

As such, the example environments 500, 600, and 700 may present several challenges upon which an additional approach may improve the tracking and identifying of customers in a customer queue or line. Such an approach may be used to identify customers beyond a predefined area of a queue zone as well as to identify when a customer passes through a customer queue or line of customers without erroneously determining that the passing customer has joined a customer queue of customers.

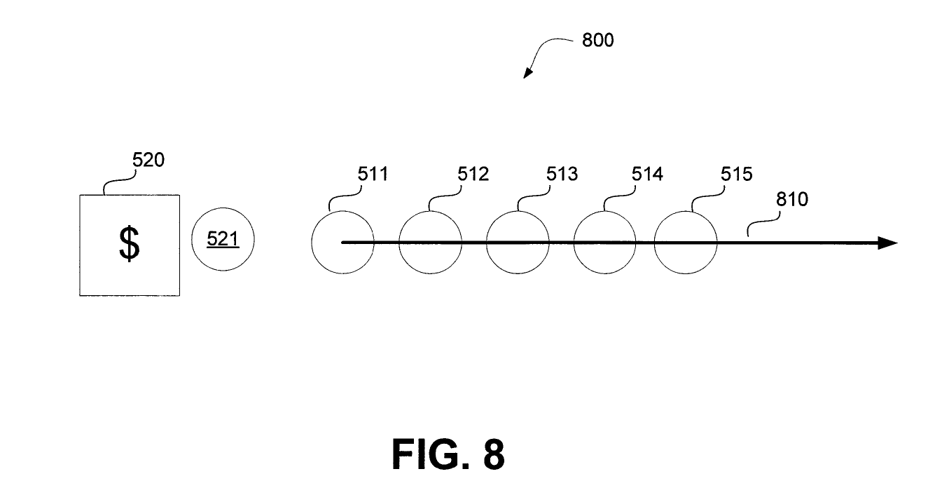

FIG. 8 illustrates an example environment 800 using an approach to determine a line based on customers in a queue. In general, the line may be generated based on customers currently in queue and may further be used to determine an additional customer who has joined the queue of customers. In some embodiments, the approach as discussed with regard to the environment 800 may use one or more cameras (e.g., from the set of cameras 415) and the system (e.g., system 405) to generate (i.e., calculate) the line and to identify an additional customer who has joined the customer queue.

As shown in FIG. 8, the environment 800 may include a point of sale location 520 associated with a customer 521 currently being served. The environment 800 may further include one or more customers waiting in a customer queue for the availability of the point of sale location 520. Customers 511, 512, 513, 514, and 515 may be waiting in a customer queue. In some embodiments, a line 810 may be generated based on the customers waiting in line or in the queue. For example, the line may be calculated based on location coordinates of the customers waiting in the queue as identified in a two dimensional image from at least one camera. In some embodiments, a line 810 may be generated based on the location of each of the customers 511, 512, 513, 514, and 515. In some embodiments, the line may be updated over time. For example, the line may be dynamically generated as an additional customer is determined to have joined the customer queue. The line may be generated based on a number of customers who are waiting in a queue. For example, a first join zone (as disclosed in further detail below) may be allocated based on where a first customer in a queue may be expected to stand for the point of sale location 520. A second customer may be determined to be standing in a customer queue behind the first customer when the second customer is identified as stopping within a predefined zone at a specified distance from the location of the first customer. When two customers are in the customer queue for point of sale location 520, the line may be generated based on the locations of the first customer and the second customer. For example, the line may be generated by the equation (x₂₋ₓ₁), (y₂−y₁). In some embodiments, x₁ and y₁ may be the x-coordinate and the y-coordinate of the first customer and x₂ and y₂ may be the x-coordinate and y-coordinate of the second customer. In some embodiments, a third customer may be identified as standing in the queue behind the second customer. In response to the third customer being identified as joining the queue behind the second customer, the line may be updated. For example, the line may now be generated based on using an ordinary least squares linear regression in two dimensions. In some embodiments, the ordinary least squares linear regression may be determined by the following equation:

y=Xβ+ε

In some embodiments, ε is the amount of error in the regression and β is the regression coefficients that may be computed by the following equation:

$$β = {( {X}^{T} X )}^{- 1} {X}^{T} y = \frac{1}{n} \sum {x}_{i} {x}_{i}^{t} {\text{)}}^{- 1} ( \frac{1}{n} \sum {x}_{i} {y}_{i} )$$

In some embodiments, E is the standard error that may be based on how far each customer in the customer queue is from the center of the generated line. For example, the distance of the center location of each customer from the generated line may be identified and the standard error may be based on the distances. In some embodiments, the standard error may be based on an average distance of the center location of each customer to the generated line.

As such, a line may be calculated based on the locations of customers waiting in a queue. As additional customers are detected to join the queue, the line may be updated or generated again based on the additional customer who has joined the queue. Furthermore, in some embodiments, the error may be determined based on the orderliness of the customers standing in the queue. Furthermore, the line may be calculated based on location coordinates of the customers as identified in a two dimensional image that represents the floor of a retail store. For example, the two dimensional image may be an overhead view of a floor location in the retail store. The line may thus be calculated based on location coordinates of the image that correspond to locations of the customers.

As such, a line may be generated based on locations of one or more customers waiting in a queue. In some embodiments, the line may be dynamically generated each time an additional customer joins the queue. Furthermore, the line may be extended beyond the last customer waiting in the queue.

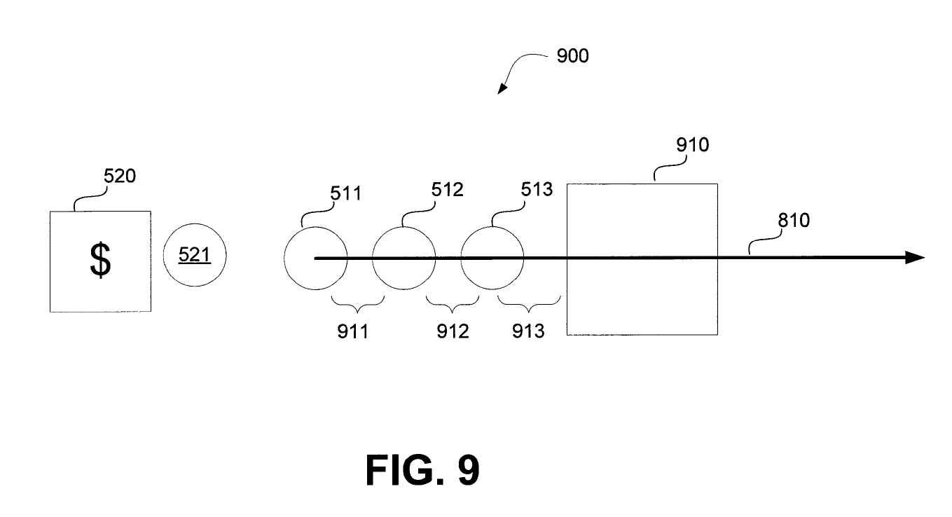

FIG. 9 illustrates an example environment 900 using an approach based on a join zone to determine whether an additional customer has joined a customer queue. In general, the environment 900 includes a similar environment as disclosed with regard to environment 800. For example, one or more cameras (e.g., from the set of cameras 415) and a system may be used to identify customers waiting in a customer queue and to identify whether an additional customer has entered a join zone.

As shown in FIG. 9, the environment 900 may include customers 511, 512, and 513 waiting in a queue for the availability of the point of sale location 520 currently serving customer 521. Furthermore, a line 810 may be generated, as disclosed with regard to FIG. 8. In some embodiments, a join zone 910 may be defined or generated on the line 810. For example, a center or centroid of the join zone may be a point on the line 810 (or regression line) and positioned beyond the last customer waiting in the queue (e.g., customer 513). In some embodiments, the spacing of the join zone 910 in relation to the last customer 513 waiting in the queue may be based on the spacing of the customers 511, 512, and 513 who are currently waiting in the customer queue. For example, the spacing 911 between the first customer 511 and the second customer 512 may be identified and the second spacing 912 between the second customer 512 and the third customer 513 may be identified. The third spacing 913 between the third customer 513 and the join zone 910 may thus be generated based on the first spacing 911 and the second spacing 912. For example, the third spacing 913 may be the average amount of spacing of the first spacing 911 and the second spacing 912. Furthermore, in some embodiments, the size of the join zone 910 may be proportional to the amount of error (e.g., ε) associated with the regression line. In some embodiments, the amount of error may be based on a distance of each location of each customer from the calculated regression line.

As such, a join zone may be generated on the previously generated line. In some embodiment, the spacing of the join zone may be based on spacing between customers who have been identified as joining a customer queue for which the line has been generated. Furthermore, the join zone may be placed beyond the last customer that has been identified as having joined the customer queue. The size of the join zone may be based on an amount of error in the line that has been generated. Furthermore, in some embodiments, a customer entering the join zone may be determined to have joined the queue, as discussed in further detail below.

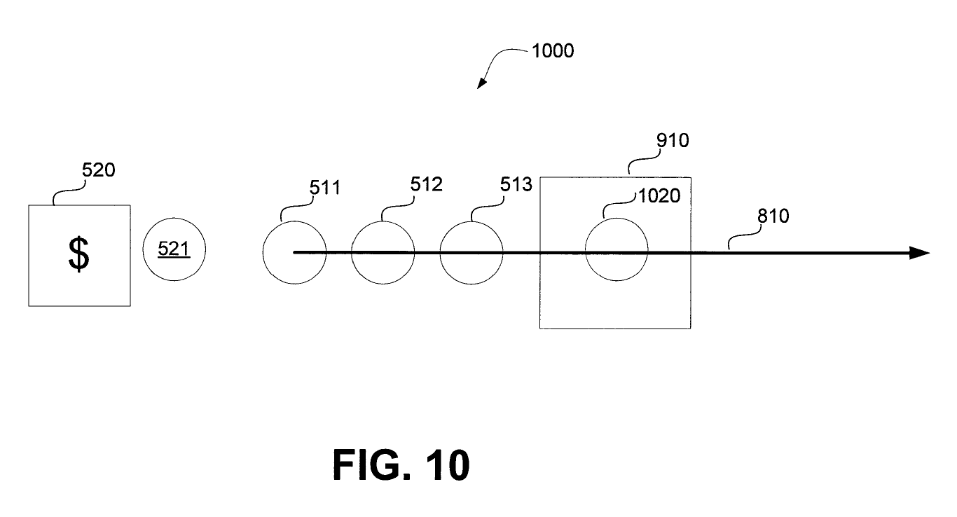

FIG. 10 illustrates an example environment 1000 showing a customer being identified as joining the customer queue based on the customer standing in a join zone. In general, the environment 1000 includes a similar environment as disclosed with regard to environment 900. For example, one or more cameras (e.g., from the set of cameras 415) and a system (e.g., system 405) may be used to generate a line based on locations of customers waiting in a queue, generate and place a join zone on the line based on the locations of the customers, and identify a customer standing in the join zone as joining the queue of customers waiting for the point of sale location.

As shown in FIG. 10, the environment 1000 may include a join zone 910. In some embodiments, the join zone 910 may be generated based on placing the centroid of the join zone 910 on the line 810 at a distance from the last customer in the queue as previously discussed. In some embodiments, one or more cameras may observe a location of a camera image corresponding to the join zone 910 and identify when a customer 1020 has stopped in the join zone for a particular period of time. For example, when the customer 1020 has stood in the join zone for an amount of time that meets or exceeds a threshold value or amount of time, then the customer 1020 in the join zone 910 may be considered to have joined the customer queue with customers 511, 512, and 513.

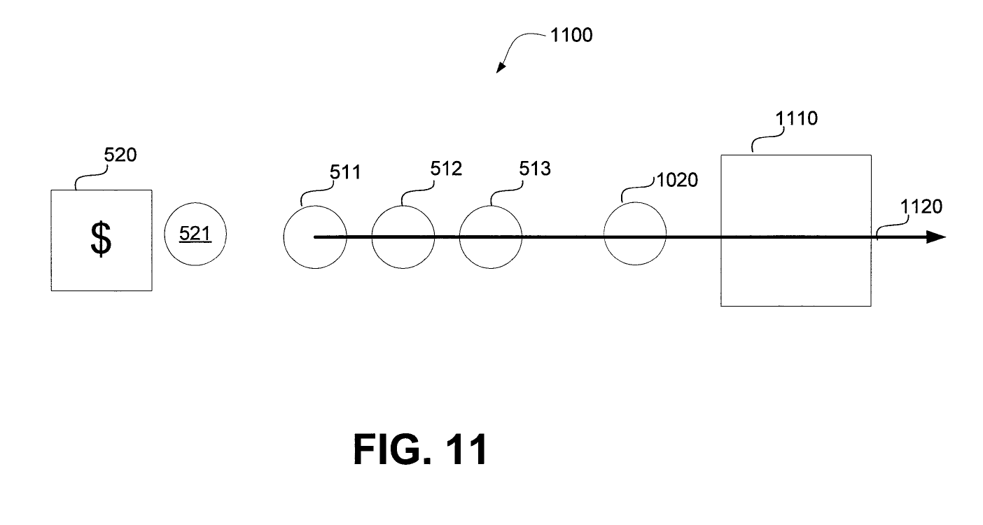

FIG. 11 illustrates an example environment 1100 showing the creation of a new join zone. In general, the environment 1100 includes a similar environment as disclosed with regard to environment 1000. For example, one or more cameras (e.g., from the set of cameras 415) and the system (e.g., system 405) may be used to generate a new join zone on the line based on the locations of the customers in the customer queue.

As shown in FIG. 11, the environment 1100 may include a join zone 1110. In some embodiments, the line or regression is calculated again in response to a new customer having been identified as joining the customer queue. For example, when the customer 1020 of FIG. 10 stood in the join zone 1020 for a particular amount of time and has been determined to have joined the customer queue, the line 810 may be dynamically re-calculated or re-defined based on the location of the prior customers (e.g., customers 511, 512, and 513) who were standing in the customer queue and based on the location of customer 1020 who has now been determined to have joined the customer queue. In some embodiments, the spacing between each of the customers who are in the customer queue may also be calculated when the new line 810 is re-calculated or re-defined. Furthermore, a new join zone 1120 may be generated or defined on the new line 810 that has been calculated or defined. For example, the centroid of the new join zone 1120 may be placed on the newly calculated line 810 and spaced according to the spacing of the customers in the customer queue (e.g., based on an average spacing between customers). Furthermore, the amount of error in the line or regression may also be determined and be used to determine the size of the new join zone 1120. In some embodiments, a location of a camera image corresponding to the new join zone 1120 may then be monitored by one or more cameras to determine whether a new customer is attempting to join the customer queue as previously discussed.

As such, a line and a join zone may be re-calculated in response to a new customer having joined the customer queue. The line may be re-calculated based on locations of all of the customers who have joined the customer queue and the spacing between the customers in the customer queue and an amount of error (e.g., spacing from the line of the customers) may be calculated in response to the new customer having joined the customer queue. Furthermore, the prior join zone may be removed and a new join zone may be re-calculated or redefined in response to the determination that the new customer has joined the customer queue. In some embodiments, the new join zone may be placed beyond the new customer that has joined the customer queue and may be spaced from the new customer based on the spacing between multiple customers in the customer queue and the size of the new join zone may be based on or proportional to an amount of error that has been recalculated with the new customer having joined the customer queue.

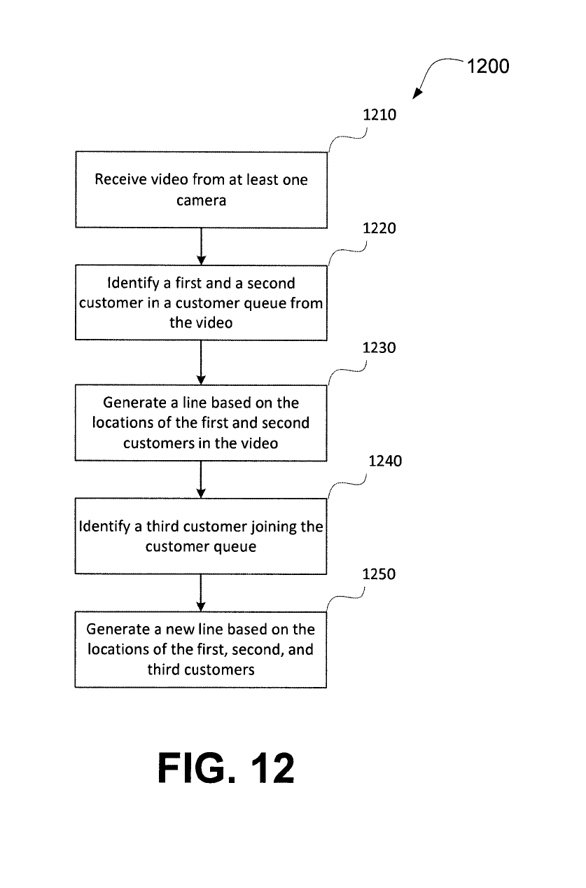

FIG. 12 is a flow diagram illustrating a method 1200 to determine or generate a line associated with a customer queue. In general, a system (e.g., system 405) may receive images or video from one or more cameras (e.g., from the set of cameras 415) and generate a line (e.g., a regression line 810) based on locations of customers in the customer queue.

As shown in FIG. 12, the method 1200 may receive, at step 1210, video from at least one camera. For example, video from one or more cameras monitoring a retail location of a store may be received. In some embodiments, the video may be from at least one overhead camera that is positioned to record an overhead video of a particular location of the floor of a store. At step 1220, a first customer and a second customer may be identified as standing in a customer queue (e.g., based on customer tracks). For example, an image from the video or the video itself may be analyzed to identify the first customer (e.g., customer 511) and the second customer (e.g., customer 512) at a location near a point of sale location (e.g., point of sale location 520). At step 1230, a line may be generated based on the locations of the first customer and the second customer. For example, a first equation may be used to generate the line when there are only two customers who have been identified as joining a customer queue. An example of such a first equation is equation (x₂−x₁), (y₂−y₁) as previously discussed, but any type of equation may be used to generate the line or regression line. At step 1240, a third customer may be identified as joining the customer queue. For example, the third customer may stand near the second customer currently standing in the customer queue. In response to the identification of the third customer joining the customer queue, at step 1250, a new line may be generated based on the locations of the first customer, second customer, and third customer.

In some embodiments, a second equation may be used to generate the line when three or more customers are identified as joining the customer queue. An example of such a second equation is the ordinary least squares linear regression as previously discussed, but any other type of equation may also be used. As such, in some embodiments, the first equation and the second equation may be different so that different equations are used to generate the line when two customers are identified as standing in the customer queue and when three or more customers are identified as standing in the customer queue. Furthermore, the line may be re-generated or re-calculated whenever a new customer is identified as standing in the customer queue. For example, if a fourth customer is identified as joining the customer queue, then the second equation (e.g., the ordinary least squares linear regression) may be used based to generate a new line associated with the customer queue such that the new line is based on the locations of the first customer, second customer, third customer, and fourth customer.

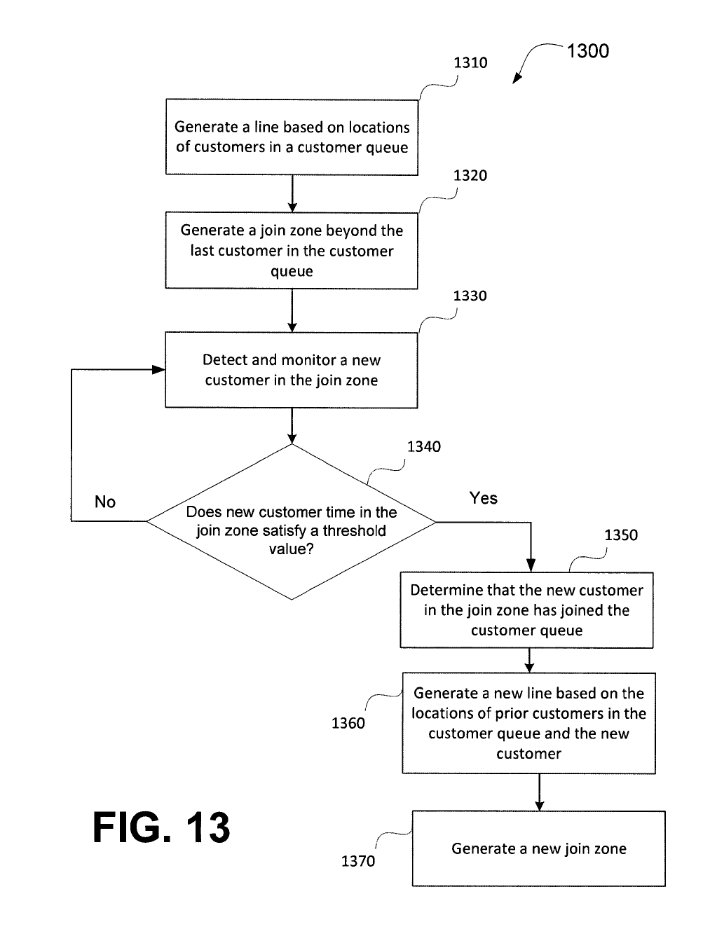

FIG. 13 is a flow diagram illustrating a method 1300 to detect a new customer joining a customer queue and to generate a new join zone in response to the new customer joining the customer queue. In general, the system (e.g., system 405) may receive input from one or more cameras (e.g., from the set of cameras 415), generate a line (e.g., a regression line 810) and a join zone (e.g., join zone 910) and generate a new line (e.g., new line 1120) and a new join zone (e.g., new join zone 1110) in response to a new customer (e.g., customer 1020) standing in the join zone and joining a customer queue.

As shown in FIG. 13, at step 1310, a line may be generated based on locations of customers in a customer queue. Furthermore, at step 1320, a join zone may be generated and placed beyond the last or final customer that has been identified as having join or being part of the customer queue. In some embodiments, the placement of the join zone may be based on the spacing between customers in the customer queue such that an average spacing between the customers is the distance between the last customer in the customer queue and the generated join zone. At step 1330, the join zone may be monitored and a new customer may be detected to have entered the join zone. At step 1340, a determination may be made as to whether an amount of time that the new customer has spent or stood in the join zone has satisfied a threshold value. For example, the join zone may be monitored such that an amount of time that the new customer is standing in the join zone may be measured. The amount of time that the new customer has been standing in the join zone may be compared to a threshold amount of time. If the amount of time that the new customer has been standing in the join zone does not meet or exceed the threshold amount of time, then the method 1300 may continue the monitor the join zone as well as the amount of time that the customer has been standing in the join zone (e.g., at step 1330). However, if the amount of time that the new customer has been standing in the join zone meets or exceeds the threshold amount of time, then at step 1350, a determination may be made that the new customer in the join zone has joined the customer queue. In response to such a determination, a new line may be generated based on the locations of prior customers who were already part of the customer queue as well as the new customer in the join zone.

In some embodiments, the new line may be a regression line based on an ordinary least squares linear regression as previously discussed. Furthermore, at step 1370, a new join zone may be generated. For example, the join zone generated at step 1320 may be removed and new join zone may be generated and placed beyond the new customer that has just joined the customer queue.

As such, in some embodiments, a line and a join zone may be generated to identify one or more customers in a customer queue. For example, a first join zone may be generated at a predefined location associated with a point of sale location. In some embodiments, the predefined location may be a location of a floor in a retail store where a first customer may be expected to stand in a customer queue to wait for the availability of the point of sale location. The first join zone may be monitored and when the first customer is determined to have stood or waited in the first join zone for an amount of time that meets or exceeds a threshold amount of time, the first customer may be identified as joining a customer queue for the point of sale location. In response to the first customer joining the customer queue, a second join zone may be generated beyond the current location of the first customer. The second join zone may be monitored such that when a second customer is determined to have stood or waited in the second join zone for an amount of time that meets or exceeds the threshold amount of time, the second customer may also be identified as joining the customer queue for the point of sale location.

In response to the second customer joining the customer queue, a line may be generated based on the location of the first customer and the location of the second customer. The line may be based on a first equation using coordinate locations of the first and second customer. Furthermore, the spacing between the first customer and the second customer may be determined. In some embodiments, the distance each of the first customer and second customer are from the generated line may also be determined or calculated. A second join zone may also be generated in response to the second customer joining the customer queue. In some embodiments, the second join zone may be placed at a location beyond the location of the second customer and at a spacing based on the spacing between the first customer and the second customer. Furthermore, the boundaries or dimensions of the second join zone may be based on a standard error that is based on the distance each of the first customer and the second customer are from the generated line.

In some embodiments, the second join zone may be monitored such that when a third customer enters the second join zone, the amount of time that the third customer is in the second join zone may be identified. If the third customer is determined to have stood or waited in the second join zone for an amount of time that meets or exceeds the threshold amount of time, the third customer may also be identified as joining the customer queue for the point of sale location. In response to the third customer joining the customer queue, a new line may be generated based on the location of the first customer, the location of the second customer, and the location of the third customer. The line may be based on a second equation using an ordinary least squares linear regression based on coordinate locations of the first, second, and third customers. Furthermore, the spacing between the first customer and the second customer and between the second customer and the third customer may be determined. Furthermore, the distance each of the first customer, second customer, and third customer are from the generated new line may also be determined or calculated.

A third join zone may also be generated in response to the third customer joining the customer queue. The third join zone may be placed at a location beyond the location of the third customer and at a spacing based on the spacing between the first customer and the second customer and the spacing between the second customer and the third customer. Furthermore, the boundaries or dimensions of the third join zone may be based on a standard error that is based on the distance each of the first customer, second customer, and third customer are from the generated line.

The above examples disclose that the new line may be generated in response to a new customer joining the customer queue. However, in some embodiments, the new line may be dynamically generated at particular time intervals. For example, the new line may be periodically generated. Furthermore, the generated line is based on location coordinates of a camera image or video. For example, customers in the image or video are identified and location coordinates are determined. The line and join zone may then be generated. In some embodiments, the join zone may be defined to be at a particular location coordinate relative to the location coordinates of the camera image and a location of the image or video corresponding to the location coordinate of the join zone may then be monitored.

The example approaches and methods of FIGS. 8-13 provide many advantages when compared to the approaches using a queue zone as discussed with relation to FIGS. 5-7. For example, the approaches and methods generating the line and join zone will not erroneously identify a customer that is only passing through a customer queue as having joined the customer queue (e.g., as disclosed with relation to FIG. 6) as a join zone is monitored and a customer must stand or be located in the join zone for at least a threshold amount of time. Furthermore, the approaches and methods generating the line and join zone may be able to identify a higher number of customers as being in a customer queue. For example, the generated line may be extended indefinitely and may not be limited by the boundaries of the queue zone. As such, if there is a long line of customers (e.g., during a Black Friday sale), then the approach and method based on the generated line and join zone may be used to identify the entire customer queue as opposed to only those customers in a particular queue zone.

In some embodiments, once the customers in a customer queue have been identified, an analysis may be performed on the customers in the customer queue. For example, various statistics regarding the customer queue in a retail store may be generated. Examples of such statistics include, but are not limited to, the number of customers in the customer queue, the length and/or number of customers of the customer queue (e.g., a minimum number of customers, maximum number of customers, average number of customers, etc. over a period of time), the length or number of customers of the customer queue at various points in time (e.g., at each time interval that the new line is generated), individual tracking of customers in the customer queue and how long each of the customers were in the customer queue (e.g., a join time and an exit time for each customer), and an abandonment rate for the customer queue. In some embodiments, the abandonment rate may be based on a percentage of customers who have been identified as joining the customer queue, but have left the customer queue before reaching the point of sale location. The afore-mentioned statistics are merely examples and any type of analysis of the customer queue may be performed to determine characteristics of the customer queue and/or characteristics of each individual customer that has joined the customer queue.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. A method to identify customers in a queue, the method comprising:
identifying a first customer and a second customer in the queue in at least one image;
determining location coordinates corresponding to locations of the first customer and the second customer in the at least one image;
calculating, by a computer, a line based on the location coordinates of the first customer and the second customer;
defining a join zone including a location coordinate that is on the calculated line;
detecting that a third customer has entered a location of at least one additional image corresponding to the join zone; and
determining that the third customer has joined the queue in response to the third customer entering into the location corresponding to the join zone.

2. The method of claim 1, the method further comprising:
calculating a second line in response to the determination that the third customer has joined the queue, the second line is based on location coordinates of the first customer, second customer, and third customer.

3. The method of claim 2, wherein the line is calculated based on a first equation, the second line is calculated based on a second equation, the first equation is different than the second equation.

4. The method of claim 3, wherein the second equation is at least partly based on an ordinary least squares linear regression.

5. The method of claim 2, the method further comprising:
defining a second join zone including a location coordinate that is on the calculated second line, the location coordinate for the second join zone is placed beyond the location coordinates of the third customer and an amount of space between the location coordinate for the second join zone and the third customer is based on an amount of space between location coordinates of the first, second, and third customers.

6. The method of claim 5, wherein boundaries of the second join zone are based on an amount of distance the location coordinates of the first, second, and third customers are from the second line.

7. The method of claim 1, wherein the determination of the third customer joining the queue is further in response to the third customer being in the location corresponding to the join zone for at least a threshold amount of time.

8. A non-transitory computer readable medium carrying one or more sequences of instructions to identify customers in a queue which, when executed by one or more processors, causes the one or more processors to carry out the steps of:
identifying a first customer and a second customer in the queue in at least one image;
determining location coordinates corresponding to locations of the first customer and the second customer in the at least one image;
calculating a line based on the location coordinates of the first customer and the second customer;
defining a join zone including a location coordinate that is on the calculated line;
detecting that a third customer has entered a location of at least one additional image corresponding to the join zone; and
determining that the third customer has joined the queue in response to the third customer entering into the location corresponding to the join zone.

9. The non-transitory computer readable medium of claim 8, the steps further comprising:
calculating a second line in response to the determination that the third customer has joined the queue, the second line is based on location coordinates of the first customer, second customer, and third customer.

10. The non-transitory computer readable medium of claim 9, wherein the line is calculated based on a first equation, the second line is calculated based on a second equation, the first equation is different than the second equation.

11. The non-transitory computer readable medium of claim 10, wherein the second equation is at least partly based on an ordinary least squares linear regression.

12. The non-transitory computer readable medium of claim 9, the steps further comprising:
defining a second join zone including a location coordinate that is on the calculated second line, the location coordinate for the second join zone is placed beyond the location coordinates of the third customer and an amount of space between the location coordinate for the second join zone and the third customer is based on an amount of space between location coordinates of the first, second, and third customers.

13. The non-transitory computer readable medium of claim 12, wherein boundaries of the second join zone are based on an amount of distance the location coordinates of the first, second, and third customers are from the second line.

14. The non-transitory computer readable medium of claim 8, wherein the determination of the third customer joining the queue is further in response to the third customer being in the location corresponding to the join zone for at least a threshold amount of time.

15. A system, comprising at least one processor and memory, to identify a queue of customers in a video, the system comprising:
a module to determine location coordinates corresponding to locations of a first customer and a second customer in the queue in the video;
a module to calculate a first line based on the location coordinates of the first customer and location coordinates of the second customer;
a module to define a first zone including location coordinates that are positioned on the calculated first line;
a module to detect that a third customer has entered a location of the video corresponding to the location coordinates of the first zone; and
a module to determine that the third customer has joined the queue in response to the third customer entering into the location of the video corresponding to the first zone.

16. The system of claim 15, the system further comprising:
a module to calculate a second line in response to the determination that the third customer has joined the queue, the second line is based on location coordinates of the first customer, second customer, and third customer.

17. The system of claim 16, wherein the first line is calculated based on a first equation, the second line is calculated based on a second equation, the first equation is different than the second equation.

18. The system of claim 17, wherein the second equation is at least partly based on a linear regression.

19. The system of claim 16, the system further comprising:
a module to define a second join zone including location coordinates that correspond to a location on the calculated second line, the location coordinates for the second join zone are placed beyond the location coordinates of the third customer and an amount of space between the location coordinates for the second join zone and the third customer is based on an amount of space between location coordinates of the first, second, and third customers.

20. The system of claim 19, wherein boundaries of the second join zone are based on an amount of distance the location coordinates of the first, second, and third customers are from the second line.
